(19) United States
(12) Patent Application Publication
(10) Pub. No.: US 2015/0249580 A1
(43) Pub. Date: Sep. 3, 2015

(54) SYSTEM AND METHOD FOR PROVIDING UNCAPPED INTERNET BANDWIDTH

(71) Applicant: Korcett Holdings, Inc., Bee Cave, TX (US)

(72) Inventors: Clinton Cory, Pflugerville, TX (US); David Daugherty, Austin, TX (US)

(21) Appl. No.: 14/635,037

(22) Filed: Mar. 2, 2015

Related U.S. Application Data
(60) Provisional application No. 61/947,267, filed on Mar. 3, 2014.

(51) Int. Cl. H04L 12/24; H04L 29/08

(52) U.S. Cl. CPC H04L 41/5054; H04L 67/141

(57) ABSTRACT

A system and method which allow for uncapped bandwidth to internet users in a high density environment while ensuring a minimum ‘floor’ tier is retained using defined site bandwidth, defined default floor tier, unique algorithms for adjustments, and equal sharing distribution is described. The method includes the steps of: validating active devices for authentication; matching device with remotely and locally defined bandwidth floor tier; adding the device to a virtual pipe with the potential of a significant percentage of the total provisioned bandwidth; storing the virtual pipe within a container that ensures a minimum distribution of the defined floor tier; remaining bandwidth is distributed equally as needed to active devices in the container in real-time.

### CROSS-REFERENCE TO RELATED APPLICATIONS

The present application claims priority to U.S. Provisional Patent Appln. No. 61/947,267, filed Mar. 3, 2014, which is entitled “System and Method for Providing Uncapped Internet Bandwidth,” all of which is incorporated by reference herein.

### TECHNICAL FIELD

Computer networking requires a means of distributing access to the Internet, including allocation of data delivery rates, or bandwidth. Incumbent Internet Service Providers (ISPs) have developed methods to manage the delivery of bandwidth to single family homes, or a single subscriber account.

In high density housing the problem of distributing bandwidth has been addressed with off-the-shelf network technology. The typical approach is to deploy network infrastructure to various points throughout the facility where access to the Internet might be required. The analogy in plumbing would be to make sure you have a pipe to all points in a dwelling where access to hot or cold water is required; the pipes within the housing community are analogous to a local area network (LAN), which distribute water from the water utility, which delivers water to the community and other buildings from its system, which is analogous to a wide area network. Basic plumbing will not suffice if the size of the pipe is variable and any single point in the distribution system is capable of consuming all of the available water. In plumbing this is not problematic because pipe sizes do not change. In network design, however, one subscriber is capable of consuming all bandwidth available to the local area network. To adequately manage the distribution of bandwidth in data networks some means of bandwidth management is required.

Analysis of customer feedback from existing high density networks, sometimes called Multiple Dwelling Units (MDUs), shows that a great deal of negative customer feedback is generated by certain demographics, such as young adults, when they are not getting expected bandwidth or are limited to how much bandwidth they can ultimately receive. This kind of feedback is prevalent when offering a capped bandwidth service tier and variables that dictate individual access to bandwidth are not related to that individual's current or historic consumption of bandwidth.

Bandwidth usage for individual subscribers is highly variable: over the course of 24 hours a majority of bandwidth procured by an MDU to ensure acceptable service at peak usage remains unused when employing a capped bandwidth service tier approach.

Therefore, there is a need for a method of providing bandwidth management in a way that allows all bandwidth available to a network to be utilized but also ensures subscribers are able to receive a minimum agreed amount of bandwidth.

### SUMMARY OF THE INVENTION

Computer networks allowing internet access to multiple subscribers, such as a Local Area Network (LAN) or Wide Area Network (WAN), are known in the art to use a router and firewall, often in the same network access device (NAD). A NAD is a dedicated circuit that connects to the preferred network; it may be a dedicated computer or a server. In order to ensure performance on a larger network, bandwidth management will be required. Rather than simply capping subscribers at a designated bandwidth tier, the present invention can open the available bandwidth on a network to equally distribute amongst users as demanded.

When aggregate bandwidth consumption within any MDU grows to a point where it nears a certain percentage of the incoming data pipe, the firewall will dynamically update to lower the total bandwidth available to all subscribers by imposing a variable bandwidth limit for all subscribers. The variable bandwidth rules will be set by a Network Service Manager (NSM), which can be a service management console or program. These limits are established by the historic data applicable to a network, and the bandwidth usage history of the property and the individual subscriber. In this manner, the present invention establishes a real-time or “flexible” bandwidth floor for property-resident subscribers that will not drop below a predefined “contractual” bandwidth floor.

Information regarding bandwidth consumption for any MDU is stored in a NSM. The NSM provides access to this data through a management portal. Subscribers, service providers, property owners and other authorized service managers use the portal to access information on network performance. This information includes data concerning items such as bandwidth consumption, trouble ticket information and various alerts/triggers via email and text messaging.

The current embodiment of the present invention utilizes all available bandwidth to a network at all times. The vast majority of commercially available services packages are designed to deliver no more than a specific amount of bandwidth. This results in a situation where available bandwidth often goes unused by paying subscribers and then used by the service provider to meet over-subscribed demand. This is a common practice among ISPs and is sometimes referred to as “over-subscription”.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an illustration of bandwidth availability and usage in a capped bandwidth service tier model in comparison to the present invention.

FIG. 2 is an illustration of the network system, architecture, and requirements of the present invention.

FIG. 3 is an illustration of the subscriber flows through the firewall and virtual bandwidth pipe.

FIG. 4 is an illustration of the subscriber flows through the firewall and virtual bandwidth pipe.

### DESCRIPTION OF THE PREFERRED EMBODIMENTS

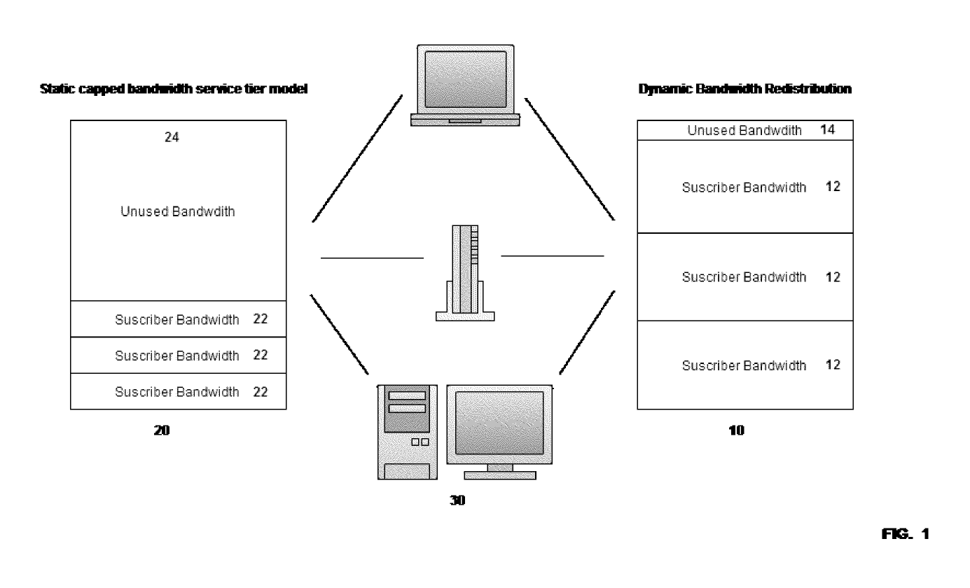

FIG. 1 shows how bandwidth distribution looks with the standard capped bandwidth service tier and present invention between three subscribers.

In FIG. 1, the total amount of bandwidth available to a network in a standard capped bandwidth service tier model is represented by 20. Subscribers 30 may have an agreed bandwidth tier 22 of 10×10 Mbit/s. This means that each subscriber will be allotted their designated bandwidth tier 22 of 10 Mbit/s but no more. This means that any excess bandwidth, represented by 24, remains unused.

In FIG. 1, total amount of bandwidth available to a network 10 is shown and will be described. Subscribers 30 will be able to utilize all but a small margin of the bandwidth 14 available to a network. A reserve 14 of bandwidth is used as a buffer to ensure that even if all the bandwidth defined for distribution at a site is utilized, there will be extra available to ensure the agreed subscriber tier can be met. The remainder of the bandwidth is available to meet the demands of active users on an equal basis.

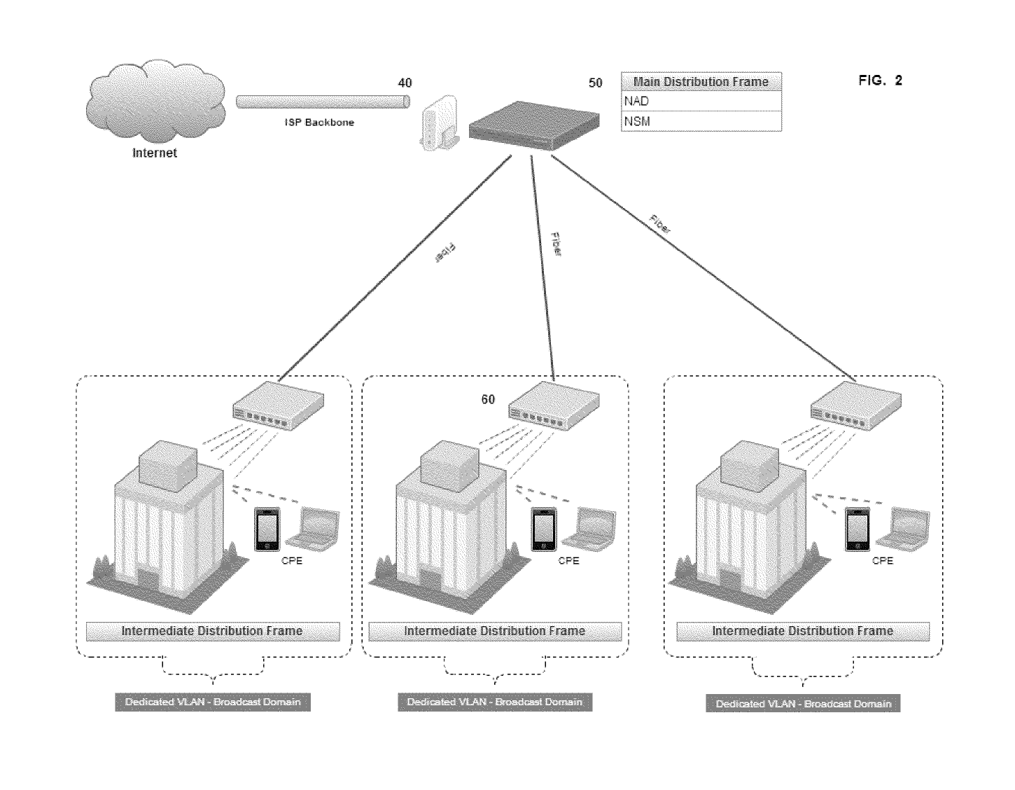

FIG. 2 shows how a standard MDU network is deployed in the current embodiment of the present invention. Elements of the network design standards include industry standard network aggregation points known as Main Distribution Frames (“MDFs”) 50, and Intermediate Distribution Frames (“IDFs”) 60.

The top of FIG. 2 shows the MDF 50, where all the IDF 60 connections ultimately come together. Standard components placed alongside the MDF 50 include devices such as the core router that provides all the standard network functionality (DHCP, DNS, NAT, Firewall, Bandwidth shaping, and other essential networking services). Once user traffic reaches the 50 and passes through the Metropolitan Area Network “MAN” 40, it will continue to the Internet.

The bottom of FIG. 2 shows an IDF 60, where traffic from end-users in specific buildings pass through to the MDF 50. The uplink from the IDF 60 to the MDF 50 is typically single-mode or multi-mode fiber. The physical layout of the MDU determines the location and number of the MDF and IDFs.

The IDF locations are also segmented on the data link layer of the OSI model (Layer 2) by the use of Virtual Local Area Networks or VLANs. By doing so, the present invention significantly reduces broadcast traffic, thereby freeing up bandwidth, as each IDF/VLAN is its own broadcast domain. These VLANs reside on the same Layer 3 network since the VLANs are part of a bridge interface on the NAD. FIG. 2 illustrates the different broadcast domains and the extent each covers.

According to a current embodiment of the present invention, the MDF 50 should contain 10/100/1000 Ethernet switches and/or fiber so long as the total provisioned bandwidth does not exceed 1 Gbit/s. If the total provisioned bandwidth exceeds 1 Gbit/s then 10 Gbit/s capable managed switches will be required. If the aggregate bandwidth delivered to the MDU will not support 1 Gbit/s then 10/100 Mbit/s switches will suffice. However, the uplink from these switches need to support more than 100 Mbit/s. If a network does have adequate bandwidth to deliver greater than 100 Mbit/s to subscribers than 10/100/1000 IDF switches are required. Additionally, if aggregate traffic from an IDF, 60, may exceed 1 Gbit/s then 10 Gbit/s uplinks should be considered.

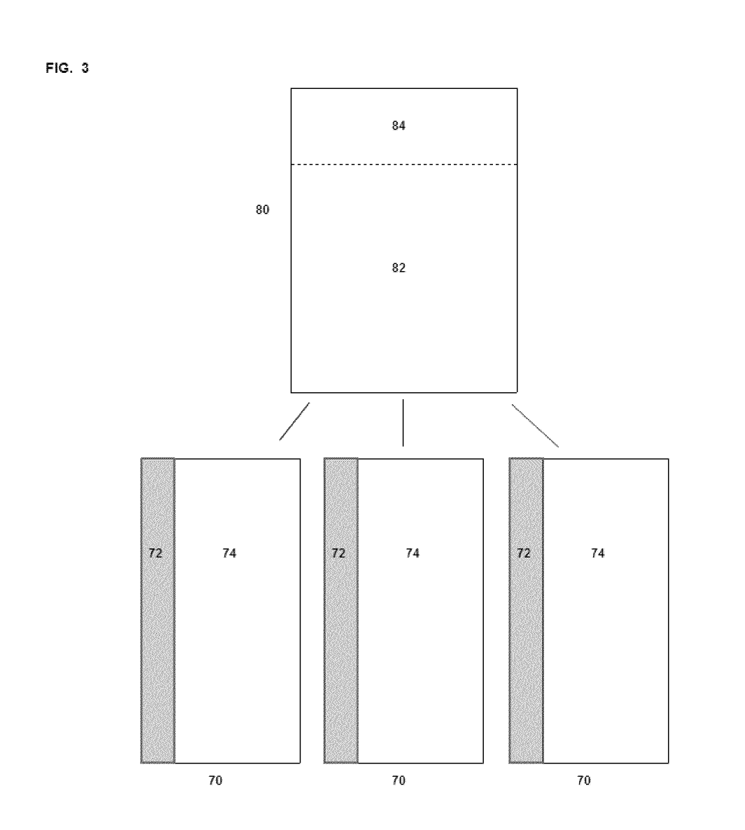

In FIG. 3, the total bandwidth available for a network 80 is shown and will be described. The total bandwidth provided then has a percentage taken away to simulate a pipe with slightly less bandwidth, which consists of bandwidth that is not included when defining how much bandwidth is available for distribution on the LAN 84, along with the remainder, which is bandwidth available for distribution 82.

The NAD uses MDU bandwidth defined in its configuration to determine how much bandwidth can be distributed. It also uses this value to reduce subscriber bandwidth when the total MDU bandwidth consumption approaches the maximum available bandwidth to the site.

The NAD is aware of the total bandwidth delivered to an MDU and, in some embodiments, distributes it evenly to all registered subscribers. Different devices can be split up into different virtual ‘pipes’ to ensure a minimum bandwidth is delivered to each registered subscriber account and therefore each registered device.

The total site bandwidth is set slightly lower to ensure distribution of additional unused bandwidth does not congest the total bandwidth pipe provided to the property, ensuring stable performance and speeds. Additionally, this allows bandwidth to be dropped evenly across multiple connections as total consumption approaches site maximums. This allows site bandwidth to be evenly distributed (within a % total site bandwidth) to decrease the chance of exceeding the network's maximum pipe size.

In FIG. 3, a subscriber 70, has been allocated a minimum bandwidth tier 72, which is the nominal amount of bandwidth allocated to, and received by, the subscriber. If available, the subscriber may receive excess bandwidth 74 in addition to the contracted bandwidth tier. In some embodiments, distribution of extra bandwidth may be equally split among subscribers as demanded by each subscriber.

In further embodiments, if bandwidth utilization continuously meets or exceeds bandwidth available for distribution 82, then capped tiers are introduced until bandwidth congestion is alleviated. In other embodiments, an alternative bandwidth level, rather than capped tiers, may be introduced. The alternative bandwidth level may be determined, for example and without limitation, by gradually tapering bandwidth allocation until congestion is relieved. Moreover, bandwidth allocation may be tapered by dividing bandwidth available for distribution 82 into successive bandwidth tiers until bandwidth congestion is alleviated or the capped tier 72 is reached. In some embodiments, such bandwidth tiers may be determined by dividing the bandwidth available for distribution 82 by a predetermined number. The tapered or capped tier 72, may be removed once there again is enough bandwidth available for distribution 82. In further embodiments, the process of tapering down can be used inversely to taper up client bandwidth allocation until no taper bandwidth pipes are needed.

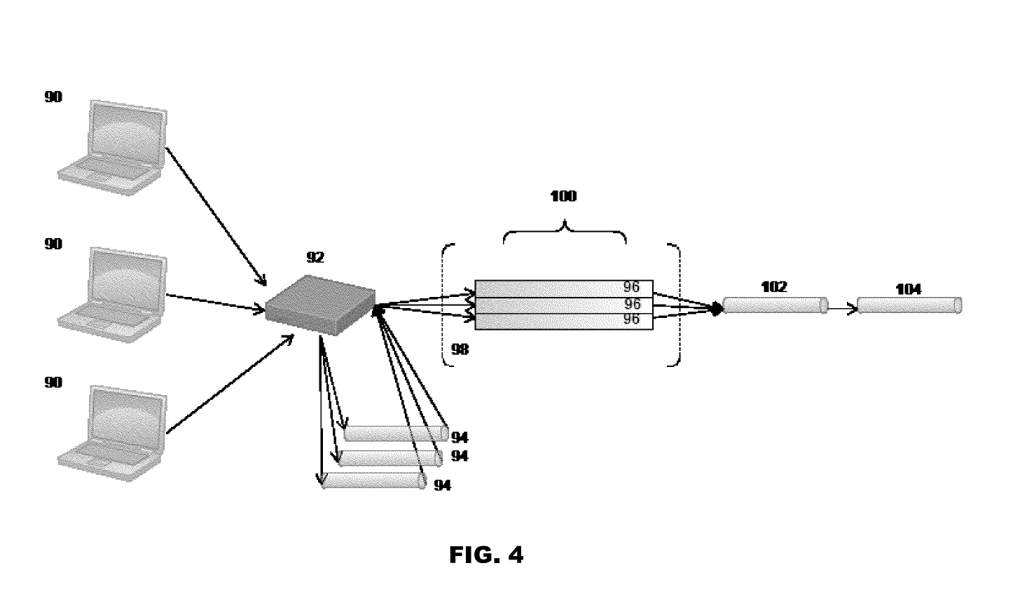

Turning now to FIG. 4, the amount of traffic passing on the NAD 92 will be captured in specific intervals. This step is performed multiple times at which point the average of the captures is calculated. The average download and upload bandwidth are both compared to the amount of bandwidth assigned to the network. If the average upload and download values are less than the assigned bandwidth to the network then Quick Fair Queuing (QFQ) immediately takes effect. It is worth noting that the amount of bandwidth assigned to a site is defined as a variable. The value assigned to that variable should be at least 5% less than the true available bandwidth. The QFQ scheduler 98 reviews the collection 100 of flows 96 passing through it.

When packets passing through a QFQ scheduler 98 are queued, all packets are immediately grouped together based off their originating MAC address. Every grouping, or flow 96, then passes through a virtual pipe 102 which is equivalent to the bandwidth assigned to the network. A QFQ scheduling algorithm intelligently provides “fair-share queuing” in the event of congestion on the virtual pipe. This means bandwidth is equally distributed to every flow if not enough bandwidth is available to satisfy clients.

A check continues in specified intervals until the average download and upload exceed the bandwidth assigned to the network. If exceeded, or rather if congestion signs appear, then devices pass through an additional virtual pipe 94. Data from client devices will pass through a floor tier pipe 94, shared by all devices associated to a user's network account management (NAM) account. A NAM is typically a profile associated to an individual that contains all of their network enabled devices, and is an account associated to a NSM. The NAM profile allows the individual to manage what network enabled devices are on their account as well as personal details and messages.

Once the data passes through the floor tier pipes 94, the data continues through the same QFQ rules previously mentioned. In some embodiments, this restrains each user to the lowest bandwidth tier that can be provided without going below the advertised floor tier. The virtual pipes emulating the floor tiers assigned to a user will be slightly higher than advertised. Various floor tiers can be utilized by various clients as well. In other embodiments, the QFQ rules may alternatively or additionally impose a variable bandwidth cap on pipes 94 or user sessions. The variable bandwidth may be based on evaluation of various parameters, including but not limited to one or more of the following: bandwidth congestion, a taper increment (tapering increase or decrease rate of bandwidth change), a floor tier defined on the NSM, an acceptable bandwidth consumption, and/or a predetermined bandwidth overhead.

A check continues in the specified interval to determine how long to keep the floor tier enabled. A safe bandwidth variable is used to check the average upload and download bandwidth. When the firewall needs to change states to accommodate congestion, firewall sets are used to activate/deactivate rules.

A system and method of providing uncapped Internet bandwidth has been shown and has been described. It is understood that various modifications, additions and alterations may be made to the invention by one skilled in the art without departing from the spirit and scope of the invention as defined in the appended claims. For example, the system and method may readily serve a variety of wide area networks (WANs) and is not limited to MDUs, but may be employed in office buildings, military bases, hotels and other areas where a fixed amount of bandwidth needs to be proportioned amongst users and devices. A Network Access Device (NAD) and Network Service Manager (NSM) are described as separate devices, but both can constitute a single device, or, if the devices are separate, the processing power of each allows tasks claimed to be performed by one of the devices to be performed by the other to be equivalent to the invention.

What is claimed is:

1. A method for variably allocating bandwidth, said method comprising the steps of:
initiating a user session on a network client device;
authenticating the user session with a Network Access Device (NAD) that communicates with a Network Service Manager (NSM);
wherein said NAD:
allocates a pipe of pre-configured bandwidth to the user session;
ensures said pipe receives a minimum level of bandwidth by storing said pipe in a queue with other similar pipes of pre-configured bandwidth allocated to other user sessions;
determines how much bandwidth remains unused on the NAD; and
distributes said unused bandwidth to all user sessions within the queue.

2. The method of claim 1, wherein the NAD is pre-configured to have a set total quantity of available bandwidth.

3. The method of claim 1, wherein the NAD is a server.

4. The method of claim 1, wherein the NSM is a service management console.

5. The method of claim 1, wherein said NAD further imposes a variable bandwidth cap on each user session if bandwidth consumption by all the user sessions exceed a bandwidth available for distribution.

6. The method of claim 5, wherein said variable bandwidth cap is based upon rules established by historical usage data.

7. The method of claim 5, wherein said variable bandwidth cap is determined by dividing said bandwidth available for distribution by a predetermined number , thereby establishing one or more successive bandwidth tiers.

8. The method of claim 5, wherein the variable bandwidth cap on each user session reduces overall bandwidth consumption below the total quantity of bandwidth available to the NAD.

9. The method of claim 1, further comprising:
determining average amount of traffic on the NAD at predetermined intervals of time; and
employing quick fair queuing (QFQ) if the average amount of traffic is more than the overall assigned bandwidth to the NAD.

10. The method of claim 9, wherein employing QFQ comprises imposing a variable bandwidth cap on each user session.

11. The method of claim 10, wherein the variable bandwidth cap imposed on each user session is determined via evaluation of one or more parameters.

12. The method of claim 11 wherein the parameters comprise a bandwidth congestion, a taper increment, a floor tier defined on NSM, an acceptable bandwidth consumption, and a predetermined bandwidth overhead.

13. A system for variably allocating bandwidth, said system comprising:
a localized network;
a network client device that initiates a user session on the localized network;
a Network Access Device (NAD) that resides on the localized network that authenticates the user session with a Network Service Manager (NSM);
wherein said NAD:
allocates a pipe of pre-configured bandwidth to the user session;
ensures said pipe receives a minimum level of bandwidth by storing said pipe in a queue with other similar pipes of pre-configured bandwidth allocated to other user sessions;
determines how much bandwidth remains unused on the NAD; and
distributes said unused bandwidth to all user sessions within the queue.

14. The system of claim 13, wherein the NAD is pre-configured to have a set total quantity of available bandwidth.

15. The system of claim 14, wherein the physical design of the localized network is segmented into a Main Distribution Frame (MDF) and an Individual Distribution Frame (IDF), traffic from a plurality of user sessions being routed through the IDF to reach the MDF, and from the MDF, to the Internet.

16. The system of claim 15 further comprising a core router that works in conjunction with the MDF, the core router providing network functionality including DHCP, DNS, NAT, Firewall, and Bandwidth Shaping.

17. The system of claim 15 wherein the location and number of IDFs is determined by the wiring infrastructure of the localized network.

18. The system of claim 15 wherein the IDFs are segmented by a plurality of Virtual Local Area Networks (VLANs).
